(19) United States
(12) Patent Application Publication
(10) Pub. No.: US 2010/0124424 A1
(43) Pub. Date: May 20, 2010

(54) Duplex printer

(75) Inventor: Manabu Iwamoto, Amimachi (JP)

Correspondence Address: THE NATH LAW GROUP, 112 South West Street, Alexandria, VA, 22314, US

(73) Assignee: RISO KAGAKU CORPORATION, Tokyo (JP)

(21) Appl. No.: 12/591,389

(22) Filed: Nov. 18, 2009

(30) Foreign Application Priority Data
Nov. 20, 2008 (JP) P2008-296888

(51) Int. Cl. G03G 15/00

(52) U.S. Cl. 399/21

(57) ABSTRACT

In a duplex printer, when it is determined that a paper jam occurs only in the first transport path that is a path upstream of a sheet stacking unit among the first and second transport paths along a feeding direction of papers (the second transport path is a path downstream of the sheet stacking unit), operations of a sheet feed unit, a first printing unit for printing on one side of papers and an intermediate sheet transport unit that are located along the first transport path, are stopped. Then, all papers stacked on the sheet stacking unit are fed out and a second printing unit prints on another side of the fed-out papers. The papers with their both sides are printed are ejected by a sheet ejection unit. According to the duplex printer, it can be prevented that papers are wasted needlessly.

### BACKGROUND OF THE INVENTION

1. Field of the Invention

The present invention relates to a duplex printer that allows automatic printing of a sheet of paper on both sides.

2. Description of Related Art

Recently, duplex printing that allows automatic printing of a sheet of paper on both front and back sides is promotionally utilized in the interest of an effective use of resources or the like. As a device that can achieve duplex printing, for example, known is a duplex stencil printer that has two cylindrical drums with perforated stencil sheets wound therearound. Printing on one side of a paper is done by one of the drums and then the paper printed on its one side is fed to the other of the drums. Subsequently, printing on another side of the paper is done by the other of the drums.

In such a duplex printer, when inks printed on the one side does not yet dry, the paper may become tainted accidentally during feeding the paper for printing on the other side or during printing on the other side of the paper.

Therefore, proposed is a duplex printer in which papers already printed its one side are temporally stacked on a stacking tray provided within the printer in order to secure time for drying inks and then printing on another side of the stacked papers is done (Patent Document 1: Japanese Patent Application Laid-Open No. 2005-29375). According to this duplex printer, it can be prevented that papers become tainted.

### SUMMARY OF THE INVENTION

Generally with a printer, when a paper jam (sheet jam, misfeed) occurs, printing is automatically stopped. Then, a user opens a cover of the printer and removes a jammed paper.

According to the above-mentioned duplex printer disclosed in the Patent Document 1, since papers already printed on its one side are temporally stocked on the stacking tray, a user may accidentally touch the papers stacked on the stacking tray during removing a jammed paper. Thus, the papers may become tainted or get winkled, so that papers are wasted needlessly.

The present invention has been achieved in order to solve the above problems and an object of the present invention is to provide a duplex printer that can reduce needlessly-wasted papers.

An aspect of the present invention provides a duplex printer that includes a sheet feed unit for feeding sheets; a first printing unit for printing on one side of the sheets fed from the sheet feed unit; an intermediate sheet transport unit for transporting the sheets of which the one side has been printed by the first printing unit; a sheet stacking unit for stacking the sheets transported from the intermediate sheet transport thereon; a sheet stack detector for detecting stacking of the sheets on the sheet stacking unit; an intermediate sheet feed unit for feeding out the sheets stacked on the sheet stacking unit in a stacked order after a predetermined sheet feed-out condition has been met; a second printing unit for printing on another side of the sheets fed out from the sheet stacking unit by the intermediate sheet feed unit; a sheet ejection unit for ejecting the sheets of which the other side has been printed by the second printing unit; a plurality of sheet detectors for detecting the sheets being transported along a first transport path and a second transport path (the first transport path is a path from the sheet feed unit to the sheet stacking unit via the first printing unit and the second transport path is a path from sheet stacking unit to the sheet ejection section via the second printing unit); and a controller. The controller is operable to: (a) determine whether or not a sheet jam occurs in the first transport path or the second transport path based on detection results of the plurality of sheet detectors, (b) stop operations of the sheet feed unit, the first printing unit and the intermediate sheet transport unit when it is determined in (a) that the sheet jam occurs only in the first transport path among the first transport path and the second transport path, (c) feed out all of the sheets stacked on the sheet stacking unit by controlling the intermediate sheet feed unit, (d) print the other side of the sheets fed out from the sheet stacking unit by controlling the second printing unit; and (e) eject the papers of which both sides have been printed by controlling the sheet ejection unit.

It is preferable that the predetermined sheet feed-out condition is a condition in which a preset time has elapsed since the sheet stack detector has detected stacking of a first sheet.

Alternatively, it is preferable that the predetermined sheet feed-out condition is a condition in which the number of stacked sheets on the sheet stacking unit has reached to a preset value, and the controller is further operable to, if the predetermined sheet feed-out condition has been met at a time when the sheet jam occurs only in the first transport path, start operations of (b), (c), (d) and (e).

Here, it is further preferable that the controller is further operable to, if the predetermined sheet feed-out condition has not been met at a time when the sheet jam occurs only in the first transport path, start an operation of (b) first and start operations of (c), (d) and (e) after a preset time has elapsed since the sheet stack detector has detected stacking of a first sheet.

In addition, it is preferable that the duplex printer further includes a display for displaying a warning display screen for notifying that the sheet jam occurs, and the controller displays the warning display screen on the display before operating (c), (d) and (e).

Further, it is preferable that the duplex printer is a stencil printer.

According to the aspect of the present invention, needlessly-wasted papers can be reduced.

### BRIEF DESCRIPTION OF THE DRAWINGS

FIG. 1 is a schematic configuration diagram showing a duplex printer according to an embodiment of the present invention;

FIG. 2 is a block diagram showing functional configurations of the duplex printer shown in FIG. 1;

FIG. 3 is a flowchart showing operations when a paper jam occurs in the duplex printer shown in FIG. 1;

FIG. 4 is an example of a warning display screen for notifying a paper jam to a user;

FIG. 5 is a partial flowchart explaining a sheet feed-out condition; and

FIG. 6 is a partial flowchart explaining another sheet feed-out condition.

### DETAILED DESCRIPTION OF THE EMBODIMENTS

An embodiment of a duplex printer according to the present invention will be explained with reference to the drawings.

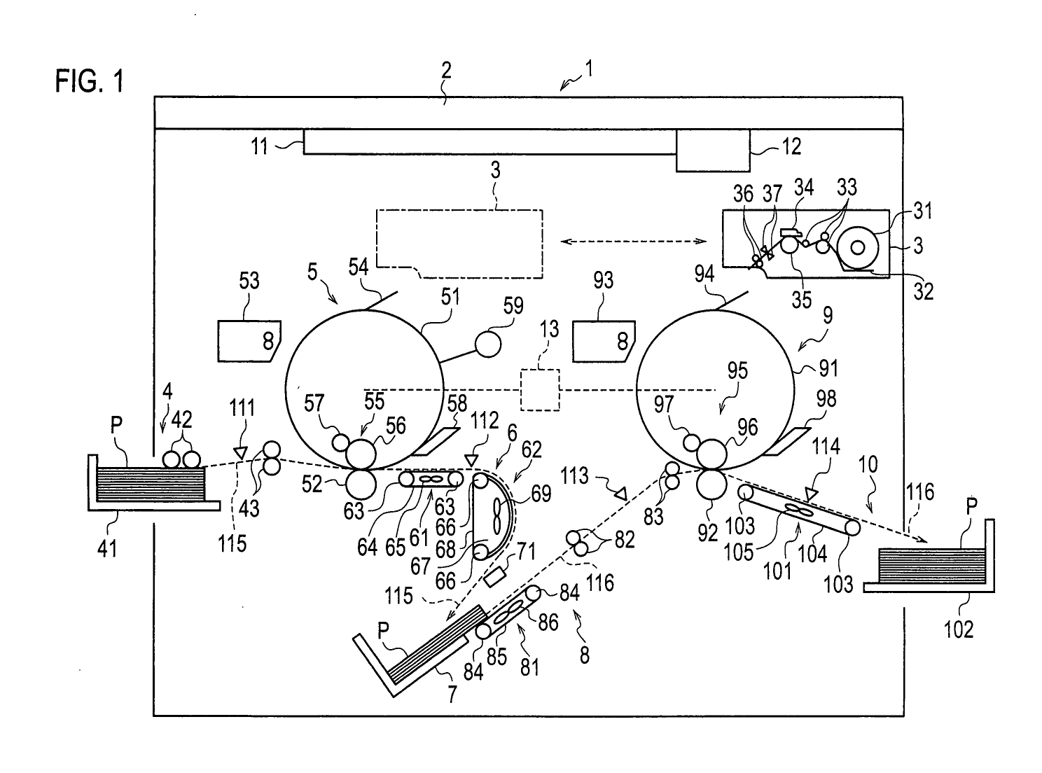

As shown in FIG. 1, the duplex printer 1 according to the present embodiment includes an original scanning unit 2, a stencil making unit 3, a sheet feed section (unit) 4, a first printing unit 5, an intermediate sheet transport section (unit) 6, a sheet stacking unit 7, an intermediate sheet feed section (unit) 8, a second printing unit 9, a sheet ejection section (unit) 10, an operation panel 11 and a controller 12.

The original scanning unit 2 is provided at an upper portion of the duplex printer 1 and can optically scan originals to be copied.

The stencil making unit 3 includes a stencil sheet container 32, feed rollers 33, a thermal head 34, a paten roller 35, stencil feed-out rollers 36 and a cutter 37. The stencil sheet container 32 contains a rolled stencil sheet 31 therewithin. The feed rollers 33 feed the stencil sheet contained within the stencil sheet container 32. The thermal head 34 is provided downstream of the feed rollers 33 along a feeding direction. Heater elements are aligned linearly along a primary sweeping direction on the thermal head 34. The platen roller 35 presses a stencil sheet 31 onto the thermal head 34. The stencil feed-out rollers 36 feeds a stencil sheet 31 already perforated by the thermal head 34. The cutter 37 cuts out a stencil sheet 31 at a desired position.

The stencil making unit 3 can be moved by a drive unit (not shown) between a first stencil sheet supply position (shown by dashed lines in FIG. 1) and a second stencil sheet supply position (shown by solid lines in FIG. 1). When the stencil making unit 3 is located at the first stencil sheet supply position, a stencil sheet can be supplied to an after-mentioned first drum 51. When the stencil making unit 3 is located at the second stencil sheet supply position, a stencil sheet can be supplied to an after-mentioned second drum 91.

The sheet feed section 4 includes a sheet feed tray 41, primary sheet feed rollers 42 and secondary sheet feed rollers 43. Papers (print media) P are stacked on the sheet feed tray 41. The primary sheet feed rollers 42 pick up the papers P sheet by sheet to feed them. The secondary sheet feed rollers 43 feed the papers P fed by the primary sheet feed rollers 42 toward the first printing unit 5 at a preset timing.

The first printing unit 5 is provided downstream of the sheet feed section 4 along the feeding direction of papers P. The first printing unit 5 includes the first drum 51, a first pressure roller 52 and a first stencil disposal unit 53.

Outer circumferential wall of the first drum 51 is made of ink-permeable porous material. The first drum 51 is rotated by a main motor 13. A damper 54 is provided on the outer circumferential wall of the first drum 51. The damper 54 clamps a perforated stencil sheet made by the stencil making unit 3, so that the stencil sheet is wound around the outer circumferential wall of the first drum 51.

An ink supply unit 55 is provided within the first drum 51. The ink supply unit 55 includes a squeegee roller 56, a doctor roller 57 and an ink supply pump (not shown). Inks are supplied from the ink supply pump to a cleavage between the squeegee roller 56 and the doctor roller 57 that are rotated in synchronization with a rotation of the first roller 51 to form ink deposition and then supplied onto an inner surface of the first drum 51.

The first pressure roller 52 is provided outside the outer circumferential wall of the first drum 51 at a position coincident with the squeegee roller 56. The first pressure roller 52 presses a paper P fed from the secondary sheet feed rollers 43 onto the outer circumferential wall of the first drum 51. The first pressure roller 52 can be moved by a drive unit (not shown) between a pressing position and a resting position. When the first pressure roller 52 is located at the pressing position, i.e., when printing is not being operated, the first pressure roller 52 is pressed onto the outer circumferential wall of the first drum 51. When the first pressure roller 52 is located at the resting position (i.e., while printing is not done), a sufficient distance can be ensured between the first pressure roller 52 and the outer circumferential wall of the first drum 51.

The first stencil disposal unit 53 removes a used stencil sheet 31 from the first drum 51 and then stocks the used stencil sheet 31 therewithin.

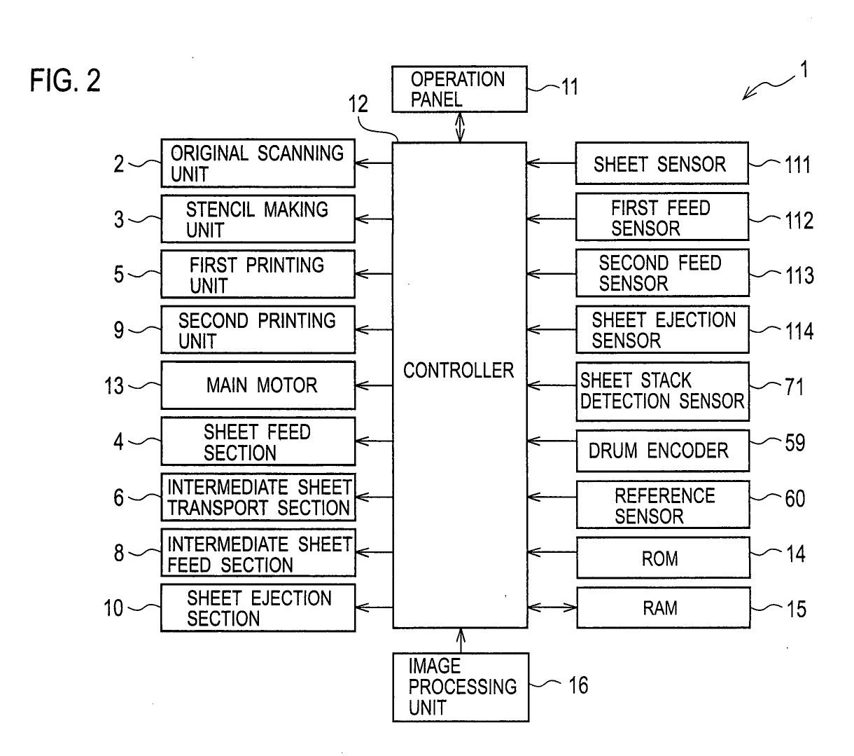

In addition, the first printing unit 5 further includes a separator 58, a drum encoder 59 and a reference sensor 60 (shown in FIG. 2). The separator 58 is provided on a downstream side of the first drum 51 along the feeding direction of papers P and peels a printed paper P apart from the first drum 51. The drum encoder 59 generates a pulse signal in synchronization with a rotational angle of the first drum 51. The reference sensor 60 detects a rotational reference position of the first drum 51.

According to the above-mentioned configurations, the first printing unit 5 clamps an edge of stencil sheet 31 fed from the stencil making unit 3 and then the first drum 51 is rotated to wind the fed stencil sheet 31 on the outer circumferential wall of the first drum 51. Papers P fed in synchronization of the rotation of the first drum 51 are pressed onto the stencil sheet 31 wound around the first drum 51, so that inks are transferred onto one side of the papers P through perforated portion on the stencil sheet 31 to print images on the one side of the papers P.

The intermediate sheet transport section 6 is provided downstream of the first printing unit 5 along the feeding direction of papers P. The intermediate sheet transport section 6 includes a sheet transport section (unit) 61 and a sheet reversing section (unit) 62.

The sheet transport section 61 includes a pair of pulleys 63, a continuously-looped feeding belt 64 and a fan 65. The pair of pulleys 63 is provided with a preset distance therebetween and rotated by a motor (not shown). The feeding belt 64 is placed around the pair of pulleys 63 and moved along with a rotation of the pair of pulleys 63. The fan 65 generates a suction force for suctioning papers P onto the feeding belt 64. The sheet transport section 61 receives papers P whose one side was already printed in the first printing unit 5 and transports them to the reversing section 62 with suctioning another unprinted side of the papers P on the feeding belt 64.

The sheet reversing section 62 includes a pair of pulleys 66, a curved support plate 67, a continuously-looped feeding belt 68 and a fan 69. The pair of pulleys 66 is rotated by a motor (not shown). The feeding belt 68 is placed around the pair of pulleys 66 and the support plate 67 and moved along with a rotation of the pair of pulleys 66. The fan 69 generates a suction force for suctioning papers P onto the feeding belt 68.

The sheet reversing section 62 moves the feeding belt 68 in a clockwise direction in FIG. 1 to reverse the papers P fed from the sheet transport section 61 with suctioning the other imprinted side of the papers P on the feeding belt 68. Then, the papers P are transported to the sheet stacking unit 7 with the printed one side faced down.

The sheet stacking unit 7 is provided downstream of the intermediate sheet transport section 6. At the sheet stacking unit 7, the papers P reversed at the sheet reversing section 62 are stacked with the printed one side faced down. Time for drying inks is secured by temporally stocking the papers P whose one side has been printed.

A sheet stack detection sensor (sheet stack detector) 71 is provided between the intermediate sheet transport section 6 and the sheet stacking unit 7. The sheet stack detection sensor 71 detects the papers P passing from the intermediate sheet transport section 6 to the sheet stacking unit 7.

The intermediate sheet feed section 8 includes a sheet feed out section (unit) 81, tertiary sheet feed rollers 82 and quaternary sheet feed rollers 83. The sheet feed out section 81 feeds out the papers P stacked on the sheet stacking unit 7 sheet by sheet. The tertiary sheet feed rollers 82 feed the papers P fed out by the sheet feed out section 81. The quaternary sheet feed rollers 83 subsequently feed the papers P fed from the tertiary sheet feed rollers 82 toward the second printing unit 9 at a preset timing.

The sheet feed out section 81 has the same configurations as those of the sheet transport section 61. Namely, the sheet feed out section 81 includes a pair of pulleys 84, a continuously-looped feeding belt 85 and a fan 86. The pair of pulleys 84 is provided with a preset distance therebetween and rotated by a motor (not shown). The feeding belt 85 is placed around the pair of pulleys 84 and moved along with a rotation of the pair of pulleys 84. The fan 86 generates a suction force for suctioning papers P onto the feeding belt 85.

The sheet feed out section 81 is controlled by the controller 12 to start feeding-out of the undermost paper P from the papers P stacked on the sheet stacking unit 7 sheet by sheet after a preset time has elapsed since the sheet stack detection sensor 71 has detected the first paper P to be stacked on the sheet stacking unit 7.

The second printing unit 9 is provided downstream of the intermediate sheet feed section 8 along the feeding direction of papers P and has the same configurations to those of the first printing unit 5. Namely, the second printing unit 9 includes the second drum 91, a second pressure roller 92 and a second stencil disposal unit 93.

The second drum has the same configurations as those of the first drum 51. Namely, a clamper 94 is provided on an outer circumferential wall of the second drum 91. The second drum 91 is rotated by the main motor 13 in synchronization with the rotation of the first drum 51.

An ink supply unit 95 is provided within the second drum 91. Inks are supplied from an ink supply pump (not shown) to a cleavage between a squeegee roller 96 and a doctor roller 97 that are rotated in synchronization with a rotation of the second roller 91 to form ink deposition and then supplied onto an inner surface of the second drum 91.

The second pressure roller 92 is provided outside the outer circumferential wall of the second drum 91 at a position coincident with the squeegee roller 96. The second pressure roller 92 presses a paper P fed from the quaternary sheet feed rollers 83 onto the outer circumferential wall of the second drum 91. The second pressure roller 92 can be moved by a drive unit (not shown) between a pressing position and a resting position similarly to the first pressure roller 51.

The second stencil disposal unit 93 removes a used stencil sheet 31 from the second drum 91 and then stocks the used stencil sheet 31 therewithin.

In addition, the second printing unit 9 further includes a separator 98 and a reference sensor 8 (not shown). The separator 98 is provided on a downstream side of the second drum 91 along the feeding direction of papers P and peels a printed paper P apart from the second drum 91. The reference sensor detects a rotational reference position of the second drum 91.

According to the above-mentioned configurations, the second printing unit 9 clamps an edge of a stencil sheet 31 fed from the stencil making unit 3 and then the second drum 91 is rotated to wind the fed stencil sheet 31 on the outer circumferential wall of the second drum 91. The papers P fed in synchronization of the rotation of the second drum 91 are pressed onto the stencil sheet 31 wound around the second drum 51, so that inks are transferred onto the other side of the papers P through perforated portion on the stencil sheet 31 to print images on the other side of the papers P.

The sheet ejection section 10 is provided downstream of the second printing unit 9 along the deeding direction of papers P. The sheet ejection section 10 includes a sheet ejection section (unit) 101 and a sheet ejection tray 102.

The sheet ejection section 101 has the same configurations as those of the sheet transport section 61. Namely, the sheet ejection section 101 includes a pair of pulleys 103, a continuously-looped feeding belt 104 and a fan 105. The pair of pulleys 103 is provided with a preset distance therebetween and rotated by a motor (not shown). The feeding belt 104 is placed around the pair of pulleys 103 and moved along with a rotation of the pair of pulleys 103. The fan 105 generates a suction force for suctioning papers P onto the feeding belt 104.

The sheet ejection section 101 receives the papers P whose both sides was already printed from the second printing unit 9 and transports them to the sheet ejection tray 102 with suctioning the papers P on the feeding belt 103. Then, the papers P whose both sides were already printed and that are ejected by the sheet ejection section 101 are stacked on the sheet ejection tray 102.

The operation panel 11 is provided at the upper portion of the duplex printer 1. The operation panel 11 includes various operational keys (not shown), such as a start key for starting a stencil making operation, a printing operation or the like, a stop key for stopping the above operations, a mode selection key for selecting one of printing modes (e.g., a duplex printing mode) and numerical keys for inputting the number of sheets to be printed or the like.

In addition, a touchscreen (not shown) is provided at the operation panel 11. The touchscreen concurrently equips a function as a display device and a function of an input device. A user can perform operations such as an input of various function settings by touching a surface of the touchscreen with his/her finger or the like. Further, the operation panel 11 displays a warning display screen 120 on the touchscreen to notify a paper jam to a user, as explained later.

In the duplex printer 11, plural sheet detection sensor (sheet detectors) are provided, i.e. a sheet sensor 111, a first feed sensor 112, a second feed sensor 113 and a sheet ejection sensor 114.

A detection point of the sheet sensor 111 is set at a position between the primary sheet feed rollers 42 and the secondary sheet feed rollers 43. The sheet sensor 111 detects whether or not a paper P is fed from the primary sheet feed rollers 42. A detection point of the first feed sensor 112 is set at a position between the sheet transport section 61 and the sheet reversing section 62. The first feed sensor 112 detects whether or not a paper P is fed from the sheet transport section 61.

A detection point of the second feed sensor 113 is set at a position between the tertiary sheet feed rollers 82 and the quaternary sheet feed rollers 83. The second feed sensor 113 detects whether or not a paper P is fed from the tertiary sheet feed rollers 82. A detection point of the sheet ejection sensor 114 is set at the sheet ejection section 101. The sheet ejection sensor 114 detects whether or not a paper P is fed from the second printing unit 9.

The above-mentioned sensors 111 to 114 function as sheet detectors for detecting papers P feed along a first transport path 115 and a second transport path 116. The first transport path 115 is a path from the sheet feed section 4 to the sheet stacking unit 7 via the first printing unit 5. The second transport path 116 is a path from sheet stacking unit 7 to the sheet ejection section 10 via the second printing unit 9. Each output of the sensors 111 to 114 is supplied to the controller 12.

Note that each of the sensors 111 to 114 may be a pass-through type sensor composed of a light emitting element and a light receiving element that are located oppositely or a reflective type sensor composed of a light emitting element and a light receiving element that are located sequentially.

The controller 12 controls whole operations of the duplex printer 11 by executing processings according to control programs. The controller 12 is composed of a CPU (Central Processing Unit) that executes processings such as various arithmetic processings and input/output of data, and so on.

As shown in FIG. 2, a ROM (Read Only Memory) 14 and a RAM (Random Access Memory) 15 are connected to the controller 12. The ROM 14 stores the control programs and so on. The RAM 15 is utilized as a temporary memory storage of data and a work area for computing of the controller 12. The controller 12 controls, according to the control programs, the original scanning unit 2, the stencil making unit 3, the sheet feed section 4, the first printing unit 5, the intermediate sheet transport section 6, the intermediate sheet feed section 8, the second printing unit 9, the sheet ejection section 10, the operation panel 11 and the main motor 13.

In addition, image data is input to the controller 12 from an image processing unit 16. The image data is digital data for image processing for making a stencil sheet. The digital data to be input to the controller 12 is made through A/D conversion of electrical analog signals generated based on scanning by the original scanning unit 2.

Further, the controller 12 receives each output of the drum encoder 59, the reference sensor 60, the sheet sensor 111, the first feed sensor 112, the second feed sensor 113 and the sheet ejection sensor 114. The controller 12 calculates a rotational angle of the first drum 51 based on a reference pulse output from the reference sensor 60 and a pulse continuously output from the drum encoder 59. The controller 12 determines whether or not a paper jam occurs based on the calculated rotational angle and the outputs of the sheet sensor 111, the first feed sensor 112, the second feed sensor 113 and the sheet ejection sensor 114.

Furthermore, the controller 12 also receives an output of the sheet stack detection sensor 71. The controller 12 controls the sheet feed out section 81 of the intermediate sheet feed section 8 so as to start feeding-out of the papers P stacked on the sheet stacking unit 7 sheet by sheet in a stacked order after the preset time has elapsed since the sheet stack detection sensor 71 has detected the first paper P to be stacked on the sheet stacking unit 7.

Next, operations of the duplex printer 1 will be explained. Main operations from stencil making to printing will be described hereinafter.

Upon receiving a command signal for starting stencil making in a duplex printing mode due to a user's operation on the operation panel 11, the first and second stencil disposal unit 53 and 93 are operated to remove used stencil sheets wound around the outer circumferential walls of the first and second drums 51 and 91, respectively.

Subsequently, the controller 12 drives the original scanning unit 2 to scan both sides of an original. Analog signals generated based on scanning by the original scanning unit 2 is converted to digital data by an A/D converter (not shown) and the digital data are transmitted to the image processing unit 16.

The image processing unit 16 converts the digital data from the A/D converter to binary data of black-and-white image data and then also generates control data for the thermal head 34 in the stencil making unit 3 based on the binary data. The image processing unit 16 transmits these data to the controller 12 as the image data. The controller 12 stores the image data relating to the both sides of the original in the RAM 15.

Subsequently, the controller 12 drives the stencil making unit 3 to execute stencil making processing for one side of the original. In the stencil making processing, the controller 12 drives the feed rollers 33 and the paten roller 35 in the stencil making unit 3 to feed a stencil sheet 31 with pressing it onto the thermal head 34. In synchronization with this feeding of the stencil sheet 31, the controller 12 retrieves the image data relating to the one side of the original from the RAM 15 to perforate the stencil sheet 31 by heats generated by the heater elements of the thermal head 34. Images corresponding to the one side of the original are transferred on the stencil sheet 31 as a perforated pattern.

Subsequently, the controller 12 moves the stencil making unit 3 to the first stencil sheet supply position using the drive unit (not shown) and causes the clamper 54 to clamp and edge of the stencil sheet 31 on which the images corresponding to the one side of the original are transferred. Then, the controller 12 rotates the first drum 51 in a predetermined direction by controlling the main motor 13 to wind the stencil sheet 31 around the outer circumferential surface of the first drum 51. An end edge of the stencil sheet 31 is cut out by the cutter 37, so that the stencil sheet 31 is entirely wound around the outer circumferential surface of the first drum 51. In this manner, a loading process of the stencil sheet 31 on the first drum 51 is completed.

Next, the controller 12 operates the stencil making unit 3 to execute stencil making processing for another side of the original similarly to the stencil making processing for the one side of the original.

Upon completion of the stencil making processing for the other side of the original, the controller 12 moves the stencil making unit 3 to the second stencil sheet supply position and then performs a loading process of the stencil sheet 31 on the second drum 91 similarly to the loading process of the stencil sheet 31 on the first drum 51.

When a command signal for starting duplex printing is input due to a user's operation on the operation panel 11 after completion of the loading processes of the stencil sheets 31 on the first and second drums 51 and 91, the controller 12 rotates the first and second drums 51 and 91 in synchronization by controlling the main motor 13. Collaterally, the controller 12 rotates the primary and secondary sheet feed rollers 42 and 43 to feed a paper P to the first drum 51. In synchronization with these operations, the controller 12 also moves the first pressure roller 52 to the pressing position to press the paper P onto the stencil sheet 31 wound around the outer circumferential surface of the first drum 51.

Supplying inks from the ink supply unit 55 to the inner surface of the first drum 51, the inks are permeated through the perforated portions of the stencil sheet 31. Then, the images corresponding to the one side of the original are printed on one side of the paper P that is pressed onto the stencil sheet 31 wound around the outer circumferential surface of the first drum 51 by the first pressure roller 52.

The paper P that has been printed on its one side is peeled apart from the first drum 51 by the separator 58 and then transported to the intermediate sheet transport section 6.

The controller 12 operates the sheet transport section 61 of the intermediate sheet transport section 6 to transport the paper P to the sheet reversing section 62. Then, the controller 12 operates the sheet reversing section 62 to reverse the paper P with suctioning another unprinted side of the paper P on the feeding belt 68. The paper P whose printed one side was faced up is transported to the sheet stacking unit 7 after the printed one side is faced down.

In a case where plural sheets of papers P are printed, the above-described series of processes is repeated. Therefore, the paper P with its printed one side faced down is sequentially stacked on the sheet stacking unit 7.

The controller 12 controls the sheet feed out section 81 of the intermediate sheet feed section 8 so as to start feeding-out of the undermost paper P from the papers P stacked on the sheet stacking unit 7 sheet by sheet after a preset time has elapsed since the sheet stack detection sensor 71 has detected the first paper P to be stacked on the sheet stacking unit 7. The papers P fed to the sheet stacking unit 7 are stocked on the sheet stacking unit 7 until the preset time has elapsed and thereby time for drying inks is secured.

Subsequently, the controller 12 rotates the tertiary and quaternary sheet feed rollers 82 and 83 to transport the paper P fed out from the sheet stacking unit 7 to the second drum 91 using the sheet feed out section 81. In synchronization with this operation, the controller 12 also moves the second pressure roller 92 to the pressing position to press the paper P onto the stencil sheet 31 wound around the outer circumferential surface of the second drum 91.

Supplying inks from the ink supply unit 95 to the inner surface of the second drum 91, the inks are permeated through the perforated portions of the stencil sheet 31. Then, the images corresponding to the other side of the original are printed on the other side of the paper P that is pressed onto the stencil sheet 31 wound around the outer circumferential surface of the second drum 91 by the second pressure roller 92.

The paper P that has been printed on its both sides is peeled apart from the second drum 91 by the separator 98 and then ejected to the sheet ejection tray 102 by the sheet ejection section 101. By repeating the above-described series of processes as many times as the number of sheets to be printed, the duplex printing process is completed.

In the above-described duplex printing operation processes, the controller 12 calculates a rotational angle of the first drum 51 based on a reference pulse output from the reference sensor 60 and a pulse continuously output from the drum encoder 59. Then, the controller 12 determines whether or not a paper jam occurs based on the calculated rotational angle and the outputs of the sheet sensor 111, the first feed sensor 112, the second feed sensor 113 and the sheet ejection sensor 114.

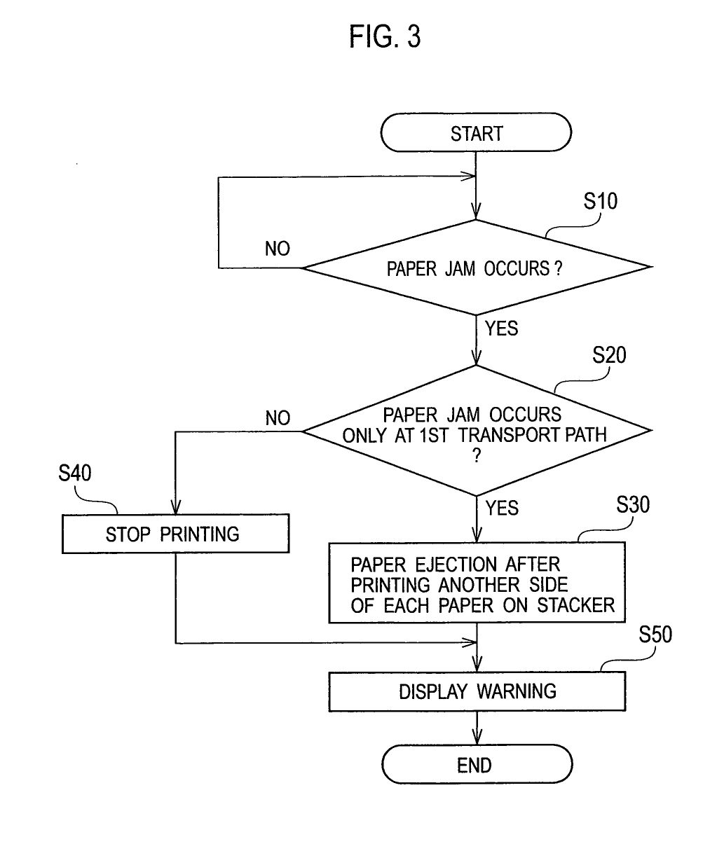

Operations of the duplex printer 1 in a case where a paper jam occurs will be explained with reference to a flowchart shown in FIG. 3.

In step S10, the controller 12 determines whether or not a paper jam(s) occurs based on detection results of the sensors 111 to 114 at each time when the rotational angle of the first drum 51 becomes coincident with each reference angle preset for the sensors 111 to 114.

When at least one of the sensors 111 to 114 doesn't detect the paper P at the time corresponds with the reference angle, the controller 12 determines that a paper jam occurs. On the other hand, when all four of the sensors 111 to 114 detect the paper P at each time corresponds with the reference angles, the controller 12 determines that no paper jam occurs.

When it is determined that no paper jam occurs (NO in step S10), the process flow returns to step S10. On the other hand, when it is determined that a paper jam occurs (YES in step S10), the controller 12 determines whether or not the paper jam(s) occurs only in the first transport path 115 in step S20. Specifically, it is determined that the paper jam(s) occurs only in the first transport path 115 in a case where the sensor that didn't detect the paper P at the time corresponds with the reference angle in step S10 is the sheet sensor 111 or the first feed sensor 112.

When it is determined that the paper jam(s) occurs only in the first transport path 115 (YES in step S20), the process flow proceeds to step S30. On the other hand, when it is determined that the paper jam(s) occurs only in the second transport path 116 or both in the first and second transport paths 115 and 116 (NO in step S20), the controller 12 stop operating the units and sections of the duplex printer 1 in step S40 and then the process flow proceeds to step S50.

In step S30, the controller 12 stops operations of the sheet feed section 4, the first printing unit 5 and the intermediate sheet transport section 6 that assume an upstream transport process of papers P from the sheet stacking unit 7. Collaterally, the controller 12 sequentially feeds out the papers P stacked on the sheet stacking unit 7 using the intermediate sheet feed section 8 to print each other side of the fed-out papers P using the second drum 91. The papers P that have been printed on their both sides are ejected by the sheet ejection section 10. On completion of ejecting all the papers P that were stacked on the sheet stacking unit 7 and are printed on their both sides, the process flow proceeds to step S50.

Note that, if the preset time has not yet elapsed since the sheet stack detection sensor 71 has detected the first paper P to be stacked on the sheet stacking unit 7 at a time when the paper jam(s) occurs only in the first transport path 115, the controller 12 starts feeding out the papers P stacked on the sheet stacking unit 7 using the intermediate sheet feed section 8 after the preset time has elapsed.

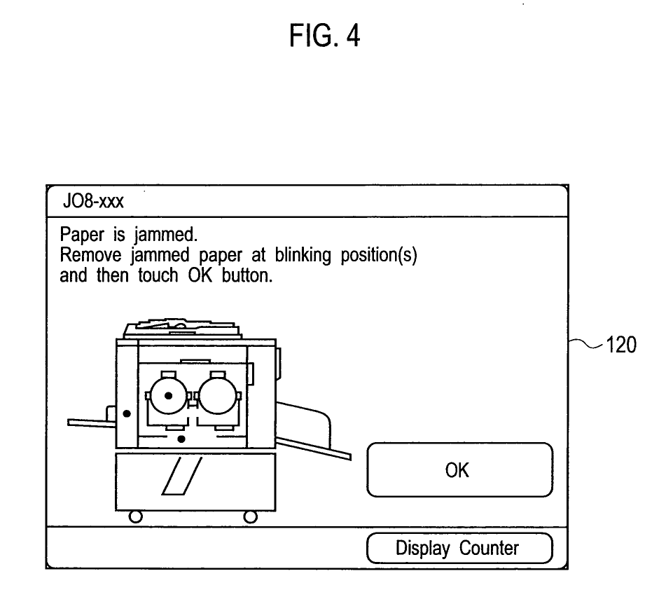

In step S50, the controller 12 displays the warning display screen 120 shown in FIG. 4 on the touchscreen of the operation panel 11 to notify a paper jam to a user.

According to the above-described embodiment, when a paper jam(s) occurs only in an upstream feed path of papers P to the sheet stacking unit 7, an upstream transport process of papers P from the sheet stacking unit 7 is stopped. Collaterally, the intermediate sheet feed section 8, the second printing unit 9 and the sheet ejection section 10 that assume a downstream transport process of papers P from the sheet stacking unit 7 are operated to print the other side of all the papers P stacked on the sheet stacking unit 7 at a time when the paper jam(s) occurs and eject them. Since there no paper P is on the sheet stacking unit 7 at a time when a user clears the paper jam(s), it can be prevented for the user to accidentally touch the papers P whose other side is not yet printed. Therefore, the papers P never become tainted or get winkled and thereby papers never be wasted needlessly.

In addition, when the paper jam(s) occurs only in the first transport path 115, the warning display screen 120 is displayed after ejecting all the papers P stacked on the sheet stacking unit 7. Therefore, it can be prevented for a user to try to clear the paper jam(s) while the papers P remain on the sheet stacking unit 7.

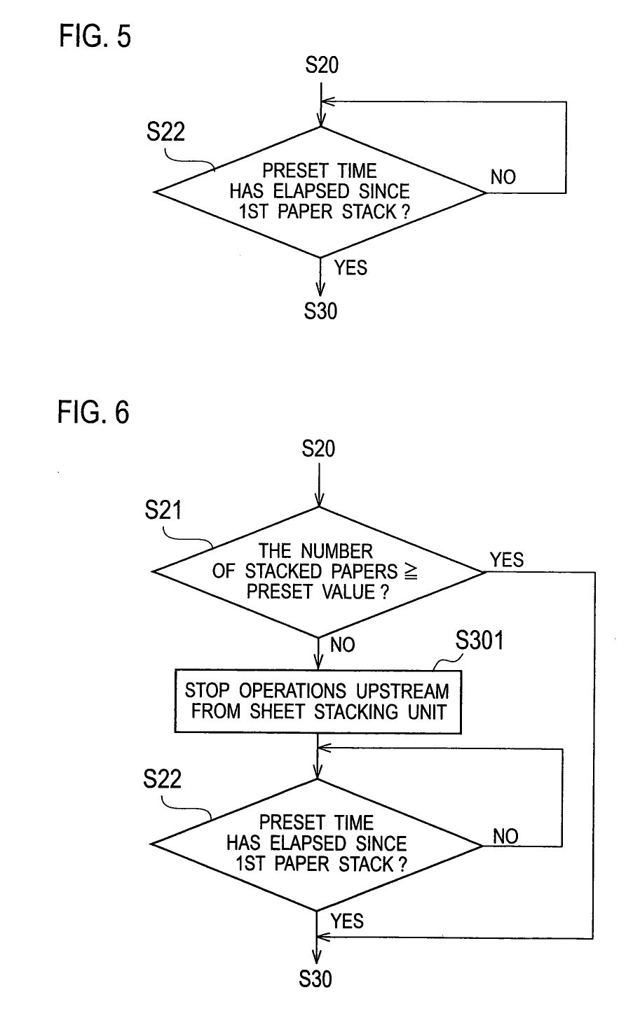

Note that, in the above descriptions, the papers P are fed out from the sheet stacking unit 7 by the sheet feed out section 81 after the preset time has elapsed since the sheet stack detection sensor 71 has detected the first paper P to be stacked on the sheet stacking unit 7 (see FIG. 5: step S22). However, feeding-out of the papers P may be started after the number of papers P stacked on the on the sheet stacking unit 7 has reached to a preset value (see FIG. 6: YES in step S21).

In this case, the controller 12 counts the number of papers P stacked on the on the sheet stacking unit 7 based on the detection results of the sheet stack detection sensor 71 and feeds out the undermost paper P from the papers P stacked on the sheet stacking unit 7 sheet by sheet after the number of stacked papers P has reached to the preset value.

According to this operation, time for drying inks can be secured for the papers P whose one side has already been printed and that are stocked on the sheet stacking unit 7.

Here, if the number of stacked sheets on the sheet stacking unit 7 has not reached to a preset value at a time when the paper jam(s) occurs only in the first transport path 115 (see FIG. 6: NO in step S21), the controller 12 firstly stops operations of the sheet feed section 4, the first printing unit 5 and the intermediate sheet transport section 6 (step S301). And then, the controller 12 starts feeding out the papers P stacked on the sheet stacking unit 7 using the intermediate sheet feed section 8 (step S30) after the preset time has elapsed since the sheet stack detection sensor 71 has detected the first paper P to be stacked on the sheet stacking unit (see FIG. 6: YES in step S22). Therefore, time for drying inks can be secured for the papers P whose one side has already been printed. Note that, in this case, the upstream transport process of papers P from the sheet stacking unit 7 (the operations at the upstream of the sheet feed section 4, the first printing unit 5 and the intermediate sheet transport section 6) is not stopped in step S30 but stopped in step S301 previously.

In the above-described embodiment, stencil printing is done using the image data made from scanning of the original by the original scanning unit 2. However, the present invention can be applied to a case where used is image data transmitted from a information processing device such as a personal computer connected via a communication link or the like.

In the above-described embodiment, papers P being transported are detected by the four sensors 111 to 114. However, the number of sensors for detecting papers P is not limited to the above embodiment. Installation positions of sensors for detecting papers P are not limited to the above embodiment, either.

1. A duplex printer comprising:
a sheet feed unit for feeding sheets;
a first printing unit for printing on one side of the sheets fed from the sheet feed unit;
an intermediate sheet transport unit for transporting the sheets of which the one side has been printed by the first printing unit;
a sheet stacking unit for stacking the sheets transported from the intermediate sheet transport thereon;
a sheet stack detector for detecting stacking of the sheets on the sheet stacking unit;
an intermediate sheet feed unit for feeding out the sheets stacked on the sheet stacking unit in a stacked order after a predetermined sheet feed-out condition has been met;
a second printing unit for printing on another side of the sheets fed out from the sheet stacking unit by the intermediate sheet feed unit;
a sheet ejection unit for ejecting the sheets of which the other side has been printed by the second printing unit;
a plurality of sheet detectors for detecting the sheets being transported along a first transport path and a second transport path, the first transport path being a path from the sheet feed unit to the sheet stacking unit via the first printing unit and the second transport path being a path from sheet stacking unit to the sheet ejection section via the second printing unit; and
a controller operable to:
(a) determine whether or not a sheet jam occurs in the first transport path or the second transport path based on detection results of the plurality of sheet detectors,
(b) stop operations of the sheet feed unit, the first printing unit and the intermediate sheet transport unit when it is determined in (a) that the sheet jam occurs only in the first transport path among the first transport path and the second transport path,
(c) feed out all of the sheets stacked on the sheet stacking unit by controlling the intermediate sheet feed unit,
(d) print the other side of the sheets fed out from the sheet stacking unit by controlling the second printing unit; and
(e) eject the papers of which both sides have been printed by controlling the sheet ejection unit.

2. The duplex printer according to claim 1, wherein
the predetermined sheet feed-out condition is a condition in which a preset time has elapsed since the sheet stack detector has detected stacking of a first sheet.

3. The duplex printer according to claim 1, wherein
the predetermined sheet feed-out condition is a condition in which the number of stacked sheets on the sheet stacking unit has reached to a preset value, and
the controller is further operable to, if the predetermined sheet feed-out condition has been met at a time when the sheet jam occurs only in the first transport path, start operations of (b), (c), (d) and (e).

4. The duplex printer according to claim 3, wherein
the controller is further operable to, if the predetermined sheet feed-out condition has not been met at a time when the sheet jam occurs only in the first transport path, start an operation of (b) first and start operations of (c), (d) and (e) after a preset time has elapsed since the sheet stack detector has detected stacking of a first sheet.

5. (canceled)

6. (canceled)

7. The duplex printer according to claim 1, further comprising
a display for displaying a warning display screen for notifying that the sheet jam occurs,
wherein the controller displays the warning display screen on the display before operating (c), (d) and (e).

8. The duplex printer according to claim 2, further comprising
a display for displaying a warning display screen for notifying that the sheet jam occurs,
wherein the controller displays the warning display screen on the display before operating (c), (d) and (e).

9. The duplex printer according to claim 3, further comprising
a display for displaying a warning display screen for notifying that the sheet jam occurs,
wherein the controller displays the warning display screen on the display before operating (c), (d) and (e).

10. The duplex printer according to claim 4, further comprising
a display for displaying a warning display screen for notifying that the sheet jam occurs,
wherein the controller displays the warning display screen on the display before operating (c), (d) and (e).

11. The duplex printer according to claim 1, wherein the duplex printer is a stencil printer.
